(19) United States
(12) Patent Application Publication
(10) Pub. No.: US 2024/0029935 A1
(43) Pub. Date: Jan. 25, 2024

(54) STORAGE CHOKE ASSEMBLY WITH COST-OPTIMIZED HOUSING

(71) Applicant: ZF Friedrichshafen AG, Friedrichshafen (DE)

(72) Inventors: Ivonne Trenz, Friedrichshafen (DE); Stefan Schaub, Küps (DE); Rico Zeiler, Bayreuth (DE); Udo Zöllner, Mistelbach (DE)

(73) Assignee: ZF Friedrichshafen AG, Friedrichshafen (DE)

(21) Appl. No.: 18/355,155

(22) Filed: Jul. 19, 2023

(30) Foreign Application Priority Data
Jul. 21, 2022 (DE) 102022207463.7

(51) Int. Cl. H01F 27/02; H01F 41/00; H01F 27/29; H01F 27/24; H01F 27/06

(52) U.S. Cl. CPC H01F 27/022; H01F 27/025; H01F 41/005; H01F 27/29; H01F 27/24; H01F 27/06

(57) ABSTRACT

A storage choke assembly for a multi-phase DC-to-DC converter for converting a DC input voltage to a DC charging voltage for charging a vehicle battery in an electric vehicle, fuel cell vehicle, or hybrid vehicle, includes a storage choke that has one or more coils, and a housing in which the storage choke is accommodated, wherein the housing has a first housing section and a second housing section, wherein the first housing section is made of a first thermosetting plastic and is in direct contact with one or more coils, wherein the second housing section is made of a second thermosetting plastic, wherein the first thermosetting plastic has a higher thermal conductivity than the second thermosetting plastic.

### CROSS-REFERENCE TO RELATED APPLICATION

This application claims priority to German Application No. DE 10 2022 207 463.7, filed on Jul. 21, 2022, the entirety of which is hereby fully incorporated by reference herein.

### FIELD

The invention relates to a storage choke assembly for a DC-to-DC converter, the DC-to-DC converter, and a method for producing the storage choke assembly.

### BACKGROUND

Purely electric vehicles and hybrid vehicles are known from the prior art, which are powered exclusively or in part by one or more electric machines forming the drive assembly. To supply these electric machines with electricity, the vehicles comprise energy storage units, in particular rechargeable batteries. Batteries are necessary for high engine power outputs, which supply a correspondingly high DC voltage of 400V or 800V, for example. These high-performance batteries are also referred to as high voltage batteries (HV batteries).

Recharging these HV batteries is challenging because a charging voltage of hundreds of volts, e.g. 800V, is needed to effectively charge the HV batteries without impacting their functionality. The charging voltage in typical charging stations for electric vehicles is normally significantly lower than this desired charging voltage of 800V, however. To supply these charging voltages, DC-to-DC converters are used, which are connected to a DC voltage source that has a lower output voltage (e.g. 400V) than the desired voltage (e.g. 800V) and to the HV battery that is to be charged.

There is a storage choke in a DC-to-DC converter, which is designed to temporarily store energy in the form of magnetic fields. Coils and choke cores are placed in a metal housing, e.g. made of aluminum, and the coils are electrically insulated against the housing by a potting compound. A heat sink with fins, e.g. a pin-fin heat sink, is normally attached to the housing. The heat sink contains a coolant channel for cooling the storage choke with a coolant flowing along the fins.

Both of the known structures used for the storage choke housing have various disadvantages. Metal housings are expensive and labor-intensive to produce. The process for electrically insulating the coils is time-consuming, and must take place in a vacuum, while also involving expensive insulating materials. Furthermore, the insulating process requires a gap between the components of a certain size.

An object of the invention is to create a storage choke assembly in which the above disadvantages are at least partially overcome.

This problem is solved according to the invention by the storage choke assembly, the method for producing the storage choke assembly, and the DC-to-DC converter according to the present disclosure. Advantageous embodiments and developments of the invention can also be derived from the present disclosure.

The storage choke assembly according to the invention is designed to convert a DC input voltage to a DC charging voltage for charging vehicle batteries, or vehicle battery packs in an electric vehicle, fuel cell vehicle, or hybrid vehicle with a multi-phase DC-to-DC converter. The storage choke assembly contains a storage choke that has one or more coils and a housing that encases the storage choke. The housing has a first section and second section, the first of which is made of a first thermosetting plastic applied directly to the one or more coils, while the second section is made of a second thermosetting plastic. The first thermosetting plastic is more thermally conductive that the second thermosetting plastic.

The housing is consequently made of a first thermosetting plastic in the section thereof that is in direct contact with the one or more coils. This first section is preferably made entirely of the first thermosetting plastic. The second section is made of a second thermosetting plastic. The second section of the housing is preferably made entirely of the second thermosetting plastic. Moreover, the first thermosetting plastic is only applied to areas on the housing where it is directly connected to a heat sink, in order to discharge heat from the coil(s). This makes it possible to limit the relatively expensive first thermosetting plastic to those parts of the housing that require cooling. The second thermosetting plastic is on the rest of the second section of the housing, in particular those parts of the housing where the coils do not or cannot come in direct contact with the environment. The second thermosetting plastic is only selected with regard to sufficient mechanical properties to ensure that the storage choke is protected against mechanical effects, or where the housing can be mechanically secured in place on the second thermosetting plastic. This significantly reduces the production costs for the storage choke assembly housing, and simplifies production thereof, without impacting the mechanical and thermal properties of the housing on the whole.

At the same time, the cooling effect can be ensured in that the first housing section is thermally coupled to a heat sink. Consequently, the relatively expensive first thermosetting plastic, which has a higher thermal conductivity, is not used for the entire housing, but only in those regions that actually contribute to the cooling of the DC-to-DC converter.

As explained above, the storage choke contains one or more coils, allowing for a modular structure. By way of example, numerous storage chokes, each of which has one coil, can be used in the DC-to-DC converter, which can be placed in different positions in the DC-to-DC converter. It is also possible to use at least one storage choke with one coil in combination with at least one other storage choke that has numerous coils in the DC-to-DC converter. A single storage choke that has numerous coils, e.g. three, can also be used in the DC-to-DC converter. These configurations are given merely by way of example, and do not limit the subject matter of the present invention. This results in an improved spatial arrangement of the power electronics, potentially with shorter electrical connections. This can also improve the thermal behavior of the storage chokes, e.g. due to the enlarged surface area. The effects of demagnetizing fields on the power electronics can also be reduced, or even entirely eliminated.

If there is a storage choke with numerous coils, the first housing section can be subdivided into numerous subsections corresponding to the numerous coils, such that each subsection is in direct contact with one of the coils, preferably in a form-fitting manner. The subsections can be separated from one another in order to further reduce the material costs for the storage choke housing.

The housing is preferably composed of just the first section and second section. At the same time, the first housing section, preferably numerous subsections of the first housing section, and the second housing section are preferably coplanar on an outside of the housing lying opposite an inside of the housing that is in contact with the storage choke.

The storage choke assembly can preferably be produced in two different ways. One method for producing a storage choke assembly comprises placing a first housing section in a thermosetting tool, in which the first housing section is made of a first thermosetting plastic, and comes in direct contact with the one or more coils in a storage choke, placing the one or more coils and other components in the thermosetting tool, and coating the other storage choke components with a second thermosetting plastic such that the second thermosetting plastic forms a second housing section, which forms a housing for the storage choke assembly with the first housing section in which the first thermosetting plastic has a higher thermal conductivity than the second thermosetting plastic. The outer cores, when they are used, are preferably also placed in the tool and adhere thereto.

Alternatively, the method for producing a storage choke assembly can comprise forming a first housing section in a thermosetting tool in which the first housing section is made of a first thermosetting plastic and comes in direct contact with one or more coils in a storage choke, preferably in a form-fitting manner, placing the one or more coils of the storage choke therein, along with other components, in particular a core housing composed of a receiver core and outer core plates, in the thermosetting tool, potentially providing the one or more coils with terminals, coating the rest of the storage choke components, as well as the connections on the terminals, with a second thermosetting plastic, such that the second thermosetting plastic forms a second housing section that forms a housing with the first housing section for the storage choke assembly, wherein the first thermosetting plastic has a higher thermal conductivity than the second thermosetting plastic.

These methods also have the advantage that when coating the other storage choke components, in particular a core housing made of receiver cores and outer core plates, as well as any connections on the terminals, a cross-linking of the first thermosetting plastic with the second thermosetting plastic can take place, resulting in a housing with good electrical insulating properties.

According to one embodiment, the housing has an upper surface, a lower surface, and side walls connecting the upper surface to the lower surface, wherein the upper surface and the parts of the side walls bordering on the upper surface form an upper region of the storage choke, wherein the terminals for the storage choke are in the upper region, in particular the upper surface, and the side walls have one or more fasteners in the form of projections. The housing is preferably cubical. Four side walls connect the upper surface to the lower surface to form the cube. The angles at the edges between the walls and surfaces are substantially 90°. The upper region can contain the upper surface of the storage choke and up to 50% of the upper half, preferably no more than 10% of the upper half, of each of the side walls. By way of example, there can be two or more, preferably four or more, six or more, or eight or more, projections on the side walls that form fasteners, preferably on two opposing side walls. These projections are preferably designed to receive screws for connecting the storage choke assembly to the housing for the DC-to-DC converter, and for cooling it with a coolant fluid, in order to ensure a reliable operation. By way of example, these projections can preferably contain holes. It is advantageous that the projections forming the fasteners can be produced when creating the second housing section through the use of an appropriate thermosetting plastic, e.g. in the framework of the method for producing the storage choke assembly.

According to one embodiment, the first thermosetting plastic and second thermosetting plastic are cured such that the first and second thermosetting plastics are cross-linked. This involves the formation of covalent bonds between the first thermosetting plastic and the second thermosetting plastic. This results in a housing with sufficient electrical insulating properties, and potentially improves the mechanical durability of the storage choke assembly.

According to one embodiment, the storage choke has choke cores with receiver cores for the one or more coils, and outer core plates, wherein the receiver cores with the one or more coils therein are placed between the outer core plates. The storage choke assembly preferably has at least three coils. The coils are magnetically coupled to one another by the choke cores. The choke cores are formed by two different types of cores. In particular, the choke cores comprise numerous receiver cores for the coils and two outer core plates, between which the receiver cores are vertical, with the coils therein. The coils can also be in mounts between the outer core plates and the coils, such that they keep the coils spaced apart. The components of the storage choke, including the coils, are preferably glued together. This results in a sufficient insulation of the storage choke components and further improves the mechanical strength of the storage choke assembly.

According to one embodiment, the storage choke assembly also has a heat sink that is thermally connected or coupled to the first housing section. The thermal connection of the heat sink can span the entire lower surface of the storage choke, preferably on a thermally conductive layer between the lower surface of the storage choke and the heat sink. The heat sink can also be thermally connected directly to the first housing section. If the first housing section is composed of numerous subsections, a single heat sink can be thermally connected to the numerous subsections and the second housing section therebetween. This has the advantage that a smaller heat sink can be used without having a negative impact on the cooling of the storage choke. Alternatively, one heat sink can be thermally connected to each subsection. This can further improve the cooling effect.

The invention also relates to a multi-phase DC-to-DC converter for charging a DC voltage source, in particular an HV battery, in an electric vehicle, fuel cell vehicle, or hybrid vehicle. The advantages described with regard to the storage choke are also obtained for the DC-to-DC converter according to the invention when it is used with the electric axle drive for a vehicle, and a vehicle, in particular an electric vehicle, fuel cell vehicle, or hybrid vehicle that has the DC-to-DC converter according to the invention.

The thermosetting plastic can be any thermosetting plastic, in particular an epoxy resin (EP), unsaturated polyester resin (UP), vinyl ester resin (VE), phenol resin (PF) and/or polyimide resin (PI). These can have a filler that modifies the various inherent properties in a targeted manner, e.g. the thermal conductivity and/or electrical conductivity. Thermosetting plastics can be obtained with reaction injection molding (RIM) or resin transfer molding (RTM). They can be processed using injection molding, extrusion, injection compression molding, or transfer molding.

The expression, “substantially cubical,” relates to a form with eight corners, the edges of which, between the upper surface or lower surface and the side walls, form angles of “substantially 90°.” An angle of “substantially 90°” relates to an angle of 90°±10° or less, e.g. 90°±5° or less, or 90°±1° or less. “Substantially corresponding contact surfaces” are surfaces that differ by 10% or less, preferably 5% or less, or 1% or less, in each case with respect to the surface area. The expression, “upper region,” relates to the upper surface of the storage choke and at most 50% of the surface are, preferably no more than 10% of the surface area of each of the side walls bordering on the upper surface. The expression, “storage choke component,” refers to the one or more coils and choke cores with receiver cores and outer core plates. The outer core plates are merely optional, and therefore only referred to when they are used. The expression, “further storage choke components,” refers to the “storage choke components” without the one or more coils, including the choke cores with receiver cores and outer core plates.

The invention shall be explained below in reference to the exemplary embodiments shown in the drawings.

### BRIEF DESCRIPTION OF THE DRAWINGS

FIG. 1 shows a schematic sectional view of a storage choke assembly according to one embodiment;

FIG. 2 shows a perspective view of the storage choke assembly according to FIG. 1; and

FIG. 3 shows another schematic sectional view of the storage choke assembly shown in FIGS. 1 and 2.

### DETAILED DESCRIPTION

Identical objects, functional units and comparable components are provided with the same reference symbols in all of the figures. These objects, functional units and comparable components are identical with regard to their technical features, if not otherwise indicated explicitly or implicitly in the description.

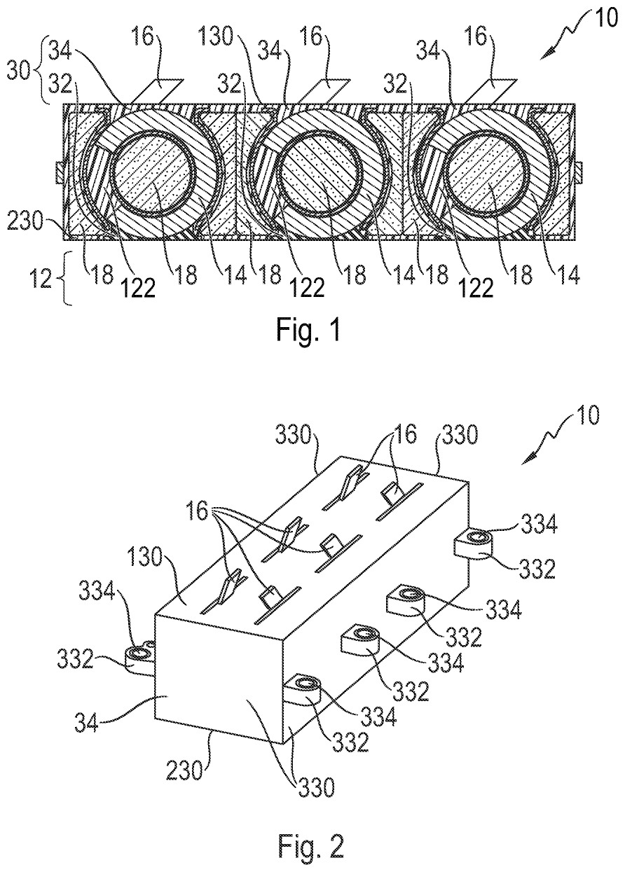

FIG. 1 shows an embodiment of a storage choke assembly 10 for use in a multi-phase DC-to-DC converter (not shown). The multi-phase DC-to-DC converter is preferably used to convert a DC input voltage from a DC voltage source to a DC charging voltage for charging a rechargeable battery, in particular a high voltage (HV) battery, in an electric vehicle, fuel cell vehicle, or hybrid vehicle. The storage choke assembly 10 comprises a storage choke that has three coils 14 in this case, for temporary energy storage of electricity in the form of magnetic fluxes.

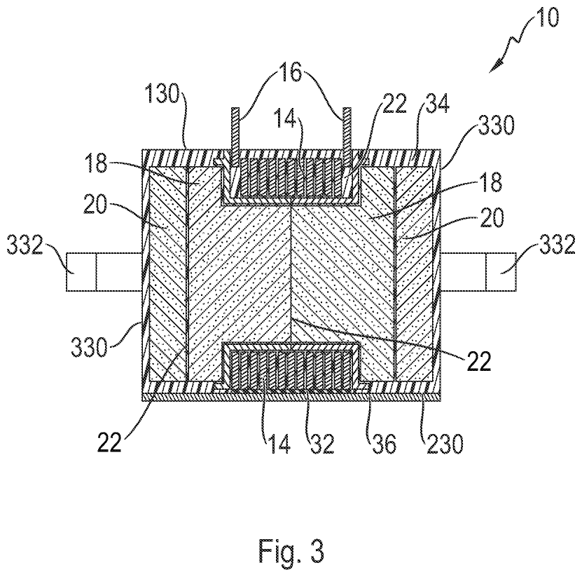

As shown in part in FIG. 1 and in greater detail in FIG. 3, the choke core 12 in the storage choke contains receiver cores 18 for the coils 14 and outer core plates 20, between which the receiver cores 18 with the coils 14 therein, are located. The terminals 16 for electrically contacting the coils 14 are on the upper surface 130 of the storage choke 11.

When a voltage is applied to the coils 14, a current flow, and therefore a magnetic flux, can be generated in the coils 14. The coils 14 are each preferably interconnected between a first capacitor and a half bridge. The number of half bridges corresponds to the number of coils 14. Each half bridge comprises a high side and a low side. The coils 14 are also preferably each connected on a side facing away from the first capacitor, between the respective high side and low side, by the terminals 16. There can be second capacitor on the side of the half bridges opposite the first capacitor. A first filter for eliminating interference signals in the DC input voltage can be interconnected between the input DC voltage source and the multi-phase DC-to-DC converter. A second filter can be interconnected between the battery and the multi-phase DC-to-DC converter for eliminating interference signals in the DC charging voltage that is generated.

It can also be seen in FIG. 1 that the storage choke assembly 10 also comprises a housing 30 that accommodates the storage choke. The housing 30 has a first housing section 32 and a second housing section 34. It can also be seen that the first housing section 32 is formed in regions of the storage choke assembly 10 where the housing 30 comes in contact with the coils 14 in a form-fitting manner. The first housing section 32 is subdivided in this case into three separate subsections, corresponding to the three coils 14, by way of example. Each of the subsections that form the first housing section 32 is in direct contact with one of the coils 14 in a form-fitting manner. By separating the first housing section 32 into numerous spatially separate subsections, the production costs for the housing 30 of the storage choke assembly 10 can be further reduced due to the material costs eliminated for the regions between the subsections. There is a second housing section 34 at the other regions where the housing 30 does not come in direct contact with the coils 14, including the receiver cores 18, the outer core plates 20, and the terminals (see FIG. 3). The coils 14 can be placed in mounts 24 between the outer core plates 18 and the coils 14, which separate the coils 14 spatially.

Thermosetting plastic 122 can also accumulate between the windings.

The first housing section 32 is made of a first thermosetting plastic, and encases each of the coils 14 in a form-fitting manner. This first thermosetting plastic is first shaped in accordance with the corresponding dimensions, and then placed in the storage choke. The storage choke is then placed in the thermosetting tool and the storage choke is coated with a second thermosetting plastic, thus forming the second housing section 34. Alternatively, the first thermosetting plastic can be formed with the corresponding dimensions in the thermosetting tool. The storage choke is subsequently placed in the thermosetting tool such that the first thermosetting plastic comes in contact with the coils 14 in the storage choke. The storage choke is then coated with a second thermosetting plastic. In these cases, the first thermosetting plastic is preferably first cured after the second thermosetting plastic for the second housing section 34 has been applied to the storage choke and comes in contact with the first housing section 32, and the storage choke is preferably coated with, or encased in, the second thermosetting plastic such that a cross linking of the first and second thermosetting plastic can take place.

Furthermore, the first housing section 32 and second housing section 34 are coplanar at a housing outer surface lying opposite the housing inner surface that is in contact with the storage choke, thus forming a planar outer surface, in particular a lower surface 230 of the storage choke assemble 10.

The cooling effect can be ensured in that a heat sink (not shown) is coupled to the lower surface 230 of the storage choke assembly 10 via the first housing section 32. Numerous heat sinks can also be used, which have contact surfaces corresponding to just the surface area of the first housing section 32, but not the entire surface area of the lower surface 230 of the storage choke assembly 10. This also reduces the costs for the heat sink and saves space.

FIG. 2 shows a perspective view of the storage choke assembly 10 shown in FIG. 1.

It can be seen in FIG. 2 that the second thermosetting plastic for the second housing section 32 completely covers the storage choke, such that it cannot be seen in FIG. 2. Only the terminals 16 for electrical contact to the coils 14 can be accessed on the upper surface 130 of the storage choke assembly 10. The terminals 16 have an exemplary geometry in this case, in which the terminals 16 for each coil 14 are offset to one another at an angle of 45° to 90°, or 55° to 75°, or 60°, in order to minimize inductive interactions. The first thermosetting plastic for the first housing section 32 and the second thermosetting plastic for the second housing section 34 are in contact with one another on the lower surface 230 (not shown), and chemically bonded to one another such that the lower surface 230 is coplanar.

It can also be seen in FIG. 2 that there are side walls 330 between the upper surface 130 and the lower surface 230, which connect the upper surface 130 and the lower surface 230 to one another. Eight projections 332, preferably with holes 334, are formed as fasteners on the side walls 330 forming the opposing side walls in the longitudinal direction of the storage choke assembly 10, with which the storage choke assembly 10 can be secured in place. It is clear that the number of projections 332 forming the fasteners, as well as their shape or design, and their locations on the housing 30, preferably only on the second housing section 34, can vary, independently of one another. It is also clear that the terminals 16 can also be on the lateral surfaces 330, preferably bordering on the upper surface 130. The advantage therewith is that the projections 332 forming the fasteners can be formed as an integral part of the housing 30 in the framework of the coating with the second thermosetting plastic forming the second housing section 34.

FIG. 3 shows another schematic sectional view of the storage choke assembly 10 shown in FIGS. 1 and 2.

It can be seen in FIG. 3 that the components of the receiver core 18 can be glued to one another and to the outer core plates 20 with an adhesive 22.

In addition to the aforementioned structure of the storage choke, it can also be derived from FIG. 3 that a thermally conductive layer 36 is formed on the lower surface 230 of the storage choke assembly 10, that borders on the housing 30, formed by a coplanar first housing section 32 made of a first thermosetting plastic, and second housing section 34 made of a second thermosetting plastic. An efficient heat transfer to a heat sink (not shown) can be obtained in this manner, which has a contact surface substantially corresponding to the surface area of the lower surface 230.

### LIST OF REFERENCE SYMBOLS

10 storage choke assembly
12 choke core
14 coil
16 terminals
18 receiver core
20 outer core plates
22 adhesive
24 mount
30 housing
32 first housing section
34 second housing section
36 thermally conductive layer
130 upper surface
230 lower surface
330 side walls
332 projections
334 holes

1. A storage choke assembly for a multi-phase DC-to-DC converter for converting a DC input voltage to a DC charging voltage for charging a vehicle battery in an electric vehicle, fuel cell vehicle, or hybrid vehicle, comprising:
a storage choke that has one or more coils; and
a housing in which the storage choke is accommodated,
wherein the housing comprises a first housing section and a second housing section,
wherein the first housing section is made of a first thermosetting plastic and is in direct contact with one or more coils,
wherein the second housing section is made of a second thermosetting plastic, and
wherein the first thermosetting plastic has a higher thermal conductivity than the second thermosetting plastic.

2. The storage choke assembly according to claim 1, wherein the first housing section is in form-fitting contact with the one or more coils.

3. The storage choke assembly according to claim 1,
wherein the housing comprises an upper surface, a lower surface opposite the upper surface, and side walls connecting the upper surface and lower surface,
wherein the upper surface and regions of the side walls bordering on the upper surface define an upper region of the storage choke,
wherein terminals for the storage choke are on the upper region, and
wherein the first housing section that is in contact with the one or more coils is only formed on the lower surface of the housing.

4. The storage choke assembly according to claim 3, wherein the terminals are on the upper surface.

5. The storage choke assembly according to claim 3, wherein a thermally conductive layer that is in contact with the first housing section and potentially the second housing section is applied to the lower surface of the housing.

6. The storage choke assembly according to claim 1, wherein a difference in thermal conductivity between the first thermosetting plastic and the second thermosetting plastic is at least 0.1 W (m*K)⁻¹.

7. The storage choke assembly according to claim 1,
wherein the housing has an upper surface, a lower surface opposite the upper surface, and side walls connecting the upper surface and the lower surface,
wherein the upper surface and regions of the side walls bordering on the upper surface define an upper region of the storage choke,
wherein terminals for the storage choke are on the upper region, wherein the side walls have one or more projections forming fasteners.

8. The storage choke assembly according to claim 7, wherein the terminals are on the upper surface.

9. The storage choke assembly according to claim 1, wherein a curing of the first thermosetting plastic and the second thermosetting plastic takes place such that the first thermosetting plastic and the second thermosetting plastic are cross linked.

10. The storage choke assembly according to claim 1, wherein the storage choke comprises choke cores that have receiver cores for the one or more coils, and
wherein the receiver cores containing the one or more coils are placed between the outer core plates.

11. The storage choke assembly according to claim 10, wherein the storage choke has at least one outer core plate that is connected on an outside to at least two receiver cores.

12. The storage choke assembly according to claim 11, wherein the at least one outer core plate is connected with adhesive to the at least two receiver cores.

13. The storage choke assembly according to claim 1, comprising:
a heat sink that is thermally connected to the first housing section.

14. A multi-phase DC-to-DC converter for converting a DC input voltage to a DC charging voltage for charging a vehicle battery in an electric vehicle, fuel cell vehicle, or hybrid vehicle, comprising:
the storage choke assembly according to claim 1.

15. An electric axle drive for an electric vehicle, fuel cell vehicle, or hybrid vehicle, comprising:
an electric machine;
a transmission; and
the multi-phase DC-to-DC converter according to claim 14.

16. An electric vehicle, fuel cell vehicle, or hybrid vehicle, comprising:
the multi-phase DC-to-DC converter according to claim 14.

17. A method for producing a storage core assembly, the method comprising
placing a first housing section in a thermosetting tool, wherein the first housing section is made of a first thermosetting plastic and is designed to come in direct contact with one or more coils in a storage choke;
placing the one or more coils and other storage choke components in the thermosetting tool; and
coating the other storage choke components with a second thermosetting plastic such that the second thermosetting plastic forms a second housing section that forms a housing for the storage choke assembly with the first housing section, wherein the first thermosetting plastic has a higher thermal conductivity than the second thermosetting plastic.
